(19) United States
(12) Patent Application Publication
(10) Pub. No.: US 2021/0153326 A1
(43) Pub. Date: May 20, 2021

(54) Omni-Directional Camera Based Motion Sensor for LED Light Fixtures

(71) Applicant: OPEN PLATFORM SYSTEMS LLC, Garden City, ID (US)

(72) Inventor: Dean Andrew Wilkinson, Garden City, ID (US)

(21) Appl. No.: 17/093,558

(22) Filed: Nov. 9, 2020

Related U.S. Application Data
(60) Provisional application No. 62/933,189, filed on Nov. 8, 2019.

(51) Int. Cl. H05B 47/125; H05B 45/12

(52) U.S. Cl. CPC H05B 47/125; H05B 45/12

(57) ABSTRACT

An LED light fixture having an inexpensive camera or sensor is disclosed. The LED light fixture utilizes a controller that is configured to turn the LED light on and/or adjust brightness of the LED in response to motion only within a perimeter programmed into the controller. This perimeter can be defined by known light output of known LED lenses. The ability to program light detection to be only within a given perimeter allows for the use of generic sensors, such as fisheye cameras, with varying lenses and LED bulbs to provide a lower cost option in motion sensing technology.

### PRIORITY/CROSS-REFERENCE TO RELATED APPLICATIONS

This application claims the benefit of U.S. Provisional Application No. 62/933,189, filed Nov. 8, 2019 the disclosure of which is incorporated by reference.

### TECHNICAL FIELD

The disclosure generally relates to the field of motion sensing devices. Particular embodiments relate to improved motion sensing devices for Light-Emitting Diode (LED) Light fixtures.

### BACKGROUND

LED light fixtures provide a high reliability energy saving alternative to legacy lighting technologies. LED light fixtures can provide even greater energy savings as well as provide a security feature if they dim to reduce power consumption when no one is nearby and brighten when people or moving vehicles approach. A motion sensor is required to support this feature, and the most common solution is to use a PIR (Passive Infrared Sensor). PIR sensors have limited range and large sensing zones so they are not very good at detecting people and vehicle very far away from the light fixture or detecting small motions from people moving in a local area. Another technology for sensing motion is doppler radar which has better sensitivity to small motions but is range and angle limited by radiated power limitations and antenna patterns. A better motion sensing technology is desired which can detect motion at greater distances and smaller movements.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

What is disclosed is a motion sensor for a light fixture, preferably an LED light fixture. The motion sensor is configured to detect motion in an area corresponding to the light pattern projected by the light fixture. The light pattern is configured based on the lens selected and the light source selected. Preferably an LED light source is utilized and selected based on the number of lumens desired for the area to be lit. A lens is selected based on the distribution pattern desired by the user. The motion sensor is configured to detect motion only within the light distribution pattern that is configured into the light fixture. Configuring the motion detector to only detect motion within the illuminated area results in the ability to use reduced image processing hardware and software in a controller to process the video data

In a preferred embodiment an LED light in the LED light fixture is positioned in an elevated position to illuminate below the light fixture. In a preferred embodiment the camera is directed straight down relative to the fixture so that a full hemisphere of coverage is provided. In a further preferred embodiment light fixture uses a fisheye lens. This allows the motion detector to detect motion in any direction using larger lower resolution optical zones. Thus, a lower resolution, lower cost camera imager can be used with the fish-eye lens. The lower resolution imagery further results in the ability to use reduced image processing hardware and software in a controller is required to process the video data. The imager does not require an infrared filter or other color filter(s) in order to increase sensitivity in low light environments. The use of the fisheye lens without filter provides a monochrome image that is simpler to process and yet capable of detecting motion. Supplemental infrared LEDs can be used to help provide illumination if the light fixture dims to off so that the camera has enough ambient illumination to detect moving objects.

The detection hardware and software can be configured to use techniques including, but not limited to, pixel averaging, rate of change sensitivity, adjacent zone transitions, and contrast or brightness change magnitude and rate to detect motion. Sensitivity thresholds and zone sizes and shapes can be made to be user adjustable to provide customer specific sensitivity or to account for different light distribution lens types (T2, T3, T4, T5, flood, or other available lenses), thus tailoring the motion sensor to match the area of illumination on the ground or the specific customer requirements. FIGS. 2-5 illustrate varying illustrate varying light distribution lens patterns.

In a preferred embodiment what is disclosed is a light emitting diode light fixture having a light emitting diode, a motion sensor, and a controller. The controller is configured to control the brightness of the light emitting diode and/or to turn the light emitting diode on and off in response to a signal from said motion sensor. The controller is configured to increase the brightness of the light emitting diode and/or to turn the light emitting diode on in response to a signal from said motion sensor that motion is occurring within the perimeter of an area that is illuminated by said light emitting diode. The controller is specifically configured to only respond to motion within a perimeter defined by perimeter of light distribution by the fixture. The distribution of light is typically determined by the type of lens used in association with the LED light fixture. Example lenses include the T2, T3, T4, T5, and flood lenses.

The light emitting diode light fixture of claim 1 can comprise a filter. Preferably the motion sensor is a camera having a fisheye lens.

A method of configuring a light fixture having a motion sensor is also disclosed. The method includes the step of providing a light fixture having a light emitting diode, a motion sensor, and a controller. The controller is configured to control the brightness of the light emitting diode and/or to turn the light emitting diode on and off in response to a signal from said motion sensor. The light fixture is configured to illuminate an area having a perimeter. The area illuminated is typically determined by the LED used and the lens on the LED light fixture.

The method further includes the step of configuring the controller such that only a signal from said motion sensor of motion within the perimeter of the illuminated area causes the controller to increase the brightness of the light emitting diode and/or to turn on said light emitting diode.

The method further preferably includes programming the controller such that it is configured to dim the light emitting diode and/or turn the light emitting diode off in the absence of a signal from the motion sensor that motion is occurring and said controller has determined the motion to be within the perimeter defining the area.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature

### BRIEF DESCRIPTION OF THE DRAWINGS

FIG. 1 is an illustration of a fish-eye lens for hemi-spherical coverage.

FIG. 2 is an example of T3 lens light pattern.

FIG. 3 is an example of a T4 lens light pattern.

FIG. 4 is an example of a T5 lens light pattern.

FIG. 5 is an example of light distribution from a flood lens.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

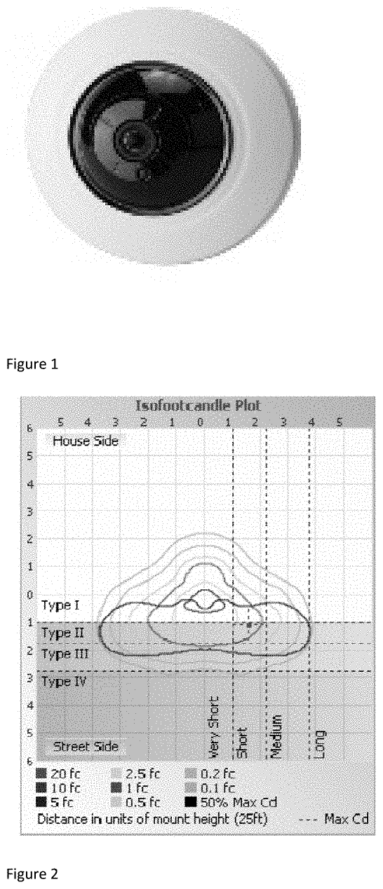

FIG. 1 illustrates an embodiment of a fish-eye lens for hemi-spherical coverage. Use of the fish eye lens provides a broad field of vision. The lens is provided as part of an LED light fixture having an LED light source. The sensor can be configured to detect motion only in the field in which the LED is illuminating.

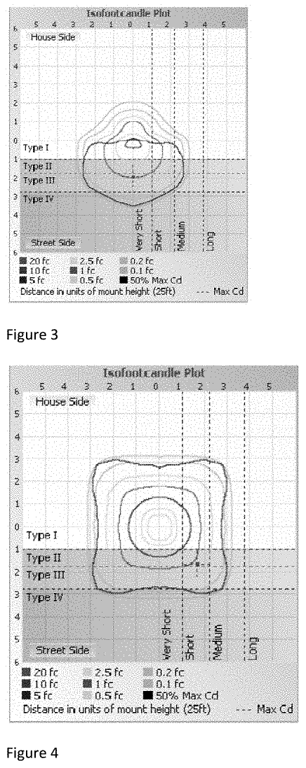

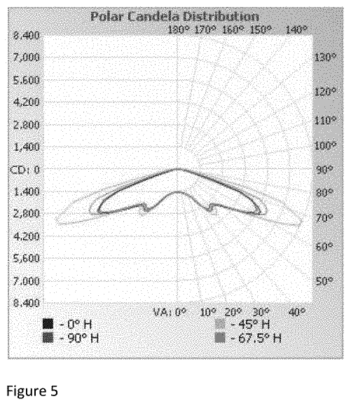

FIG. 2 depicts an example of the light pattern of a T3 lens. The motion detection software and hardware of the LED Light Fixture can be configured to detect motion and only within the illuminated zone or based on additional variables, as discussed above. The use of software to program what motion generates a response allows for the use of a lower cost camera or sensor as opposed to using a higher cost camera or sensor. FIG. 3 depicts an example of the pattern of light emitted from a T4 lens. FIG. 4 depicts the pattern of light emitted from a T5 lens. FIG. 5 depicts the light distribution from a flood lens. A generic camera or sensor can be utilized, with associated software configured to only activate the LED in certain conditions, such as motion within the predetermined, preprogrammed zone in which light is distributed by the selected lens. An LED light fixture can further be provided with varying lenses, but with the software capability of providing a variety of software configurations and the installer or user of the LED fixture selecting which preset configuration matches the LED lens of choice for the fixture.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

I claim:

1. A light emitting diode light fixture comprising:
a light emitting diode,
a motion sensor,
a controller configured to control the brightness of the light emitting diode and/or to turn the light emitting diode on and off in response to a signal from said motion sensor, wherein said motion sensor is configured to increase the brightness of the light emitting diode and/or to turn the light emitting diode on in response to a signal from said motion sensor that motion is occurring within the perimeter of an area that is illuminated by said light emitting diode.

2. The light emitting diode light fixture of claim 1, wherein said light emitting diode comprises a filter.

3. The light emitting diode light fixture of claim 1 wherein said motion sensor comprises a fisheye lens.

4. The light emitting diode light fixture of claim 1 wherein a lens of said light emitting diode is selected from a group consisting of T2, T3, T4, T5, or flood.

5. A method of configuring a light fixture having a motion sensor, said method comprising the following steps:
a) the step of providing a light fixture comprising a light emitting diode, a motion sensor, and a controller configured to control the brightness of the light emitting diode and/or to turn the light emitting diode on and off in response to a signal from said motion sensor, wherein said light fixture is configured to illuminate an area defined by a perimeter; and
b) the step of configuring said controller such that only a signal from said motion sensor of motion within said perimeter defining said area causes said controller to increase the brightness of the light emitting diode and/or to turn on said light emitting diode.

6. The method of claim 5, wherein said controller is configured to dim said light emitting diode and/or turn said light emitting diode off in the absence of a signal from said motion sensor that motion is occurring within said perimeter defining said area.
